(19) United States
(12) Patent Application Publication
(10) Pub. No.: US 2014/0012677 A1
(43) Pub. Date: Jan. 9, 2014

(54) Mobile Device Application for Dynamic Delivery of Advertising-Based Content

(71) Applicant: Paul F. Wagner, Houston, TX (US)

(72) Inventor: Paul F. Wagner, Houston, TX (US)

(21) Appl. No.: 13/723,813

(22) Filed: Dec. 21, 2012

Related U.S. Application Data
(60) Provisional application No. 61/578,394, filed on Dec. 21, 2011.

(51) Int. Cl. G06Q 30/02

(52) U.S. Cl. CPC G06Q 30/0255
USPC 705/14.64

(57) ABSTRACT

Described is a system, method, and computer readable medium for dynamically delivering advertising-based content. The system can include a first mobile device adapted to transfer data based on an end user's preferences, an advertising transmitter, and a network. The system can also include a first server adapted to store advertising-based content, a second server adapted to store test market data sent from an advertising entity, and an end user device adapted to receive advertising-based content. The computer readable medium can store a program adapted to execute instructions for receiving an input from an end user, receiving an audio signal from an advertising transmitter, transmitting a digital signal to a first server based on the received audio signal, and receiving advertising-based content from the first server. The program can further display advertising-based content options on a first mobile device for the end user to share through social media services.

### CROSS REFERENCE TO RELATED APPLICATIONS

This application claims priority to U.S. Provisional Patent Application Ser. No. 61/578,394, filed Dec. 21, 2012, the contents of which are incorporated herein by reference in its entirety.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to the delivery of advertising-based content to consumers. In one of the aspects, the invention specially relates to an apparatus for dynamically delivering advertising-based content to consumers through the aid of a mobile device application. In further aspects, the invention relates to a system and method for delivering advertising-based content between an advertising entity and an end user, thereby providing end users (i.e., consumers) with advertising-based content specifically tailored to their particular needs or purchasing needs or history.

2. Description of the Related Art

Over the past several years, global advertising spending within major media markets such as television, radio, and traditional print media (e.g., newspapers and magazines) has grown at a staggering rate. In the first quarter of 2011, for example, advertisers spent roughly $1.6 billion on radio advertisements (a 8.5% year-over-year increase), and $18.7 billion on television advertisements (a 11.9% year-over-year increase). With these increased TV and radio expenditures, advertisers are continuously searching for ways to more effectively market their products and services.

In the United States, both the radio and TV advertising sectors have established measurement systems to track consumer data. Both rely heavily on household panels and diary-based systems. The diary-based system is an important tool because it tracks which members of a particular household view any given program. TV markets typically rely on the Nielson rating system and radio markets typically employ the Arbitron rating system. Arbitron employs a device known as PPM®. PPM® is a portable device that users can take with them to use remotely. It keys into hidden signals on various radio stations in order to track channel and listening times. Recently, Arbitron has updated to a new system, PPM® 360. PPM® 360 is an electronic audience measurement device that is both portable and mobile. It employs a cellular connection in order to allow the unit to send data in a quasi-real-time manner. Although both the Nielson and Arbitron systems aim to track user behavior, both systems are limited because they are only tools for measurement. That is, they do not provide higher levels of engagement for the advertisers or consumers alike. Accordingly, advertisers are continuously looking for newer and better ways to reach their target audiences, and more effectively monitor their behavior.

One common way in which advertisers can improve the effectiveness of their advertisements is through a process known as target marketing. Target marketing involves separating groups of similar people into categories based on particular characteristics (such as geographic, demographic, and psychographic segments). Once separated into these segments, advertisers can market their products and services directly to a particular group of individuals who share similar characteristics. Targeting marketing strategies are typically more effective than mass marketing strategies because the former can narrow the advertiser's focus to only those products and services most relevant to that particular group of individuals.

One of the downsides to targeting marketing is that advertisers may inadvertently restrict the focus of their target segments too narrowly. By doing so, advertisers may be unknowingly excluding a large swath of highly relevant potential consumers from exposure to their products and services. Likewise, consumer preferences change, often quite rapidly, and thus the market segmentation data must be constantly updated in order for advertisers to effectively reach those consumers most likely to purchase their products and services.

More recently, advertisers have turned to interactive advertising strategies. Interactive advertising involves mutual action between both the advertiser and the consumer. For example, web banner ads are one form of interactive advertising. For web banner ads, an advertiser displays its advertisement on a consumer's screen, typically through a computer connected to the Internet. If the consumer so chooses, she may “click” on the banner to link to the advertising content. This process is mutually beneficial because the consumer can instantaneously receive the information about products and services she is most interested in, and the advertiser can relay additional information to the consumer without any additional cost or manual intervention. A variety of approaches have been attempted to exploit the benefits of interactive advertising strategies.

For example, U.S. Pat. No. 7,353,299 issued to Vilcauskas, Jr., et al. describes a post-session internet advertising system that may be used in media such as computers, telephones, television, radios, and similar devices. A first display is viewed in a first platform in the foreground of a media by a viewer. The viewer initiates a load triggering event and in response, a post-session advertisement is opened to display a post-session display in the background of the media.

In U.S. Pat. No. 6,898,571 to Val, et al., a technique for providing enhanced advertising over the Internet by associating an alphanumeric code with the advertisement is described. The consumer, desiring additional information regarding the advertisement, logs onto a particular website and enters the alphanumeric code to receive the additional information. The additional information may be specifically directed to a particular geographic location or otherwise customized for the particular customer.

These prior art interactive marketing solutions have several drawbacks, however. For example, web banner ads require a user to be fully engaged in the web experience for the advertisement to be effective. In other words, these advertisements are not practical to use in mobile devices when the consumer is multitasking. Furthermore, the use of alphanumeric codes forces a user to rely his memory or write notes to access the advertising content if he is not immediately able to input the code. It is therefore desirable for advertisers and consumers to have a solution that provides for an interactive and dynamic marketing scheme to overcome the problems set forth above.

### BRIEF SUMMARY OF THE INVENTION

The disclosure provides a system, method, and computer readable storage medium for dynamically delivering advertising-based content. The system can include a first mobile device adapted to transfer data based on an end user's preferences, an advertising transmitter, and a network. The system can also include a first server adapted to store advertising-based content, a second server adapted to store test market data sent from an advertising entity, and an end user device adapted to receive advertising-based content. The computer readable medium can be configured to store a program adapted to execute instructions for receiving an input from an end user, receiving an audio signal from an advertising transmitter, transmitting a digital signal to a first server based on the received audio signal, and receiving advertising-based content from the first server. The program can further display one or more advertising-based content options on a first mobile device for the end user to share through social media services.

In one embodiment, the system for dynamically delivering advertising-based content can include a first mobile device adapted to transfer data based on an end user's preferences, an advertising transmitter adapted to transmit an audio signal, and a network. The first mobile device can be adapted to be operably coupled to the network. The system can further include a first server, wherein the first server can further comprise a first database adapted to store advertising-based content, and a second server, wherein the second server can be adapted to store test market data. The first mobile device can be further adapted to receive the advertising-based content.

The end user device can be further adapted to receive advertising-based content from the first server over the network. The first mobile device can be adapted to convert the audio signal to a digital signal and transmit the digital signal to the network. The first server can be adapted to compare the digital signal with advertising data stored on the first database, and the first mobile device can be adapted to receive advertising-based content attributed with the digital signal after the first server successfully compares the digital signal with the advertising data stored on the first database. The second server can be adapted to transmit the test market data to the first server to be later stored as advertising-based content. Further, the second server can be adapted to receive test market data from an advertising entity and the test market data can be adapted to be used during a test market campaign.

In another embodiment, the method for dynamically delivering advertising-based content can include the step of transferring data to and from a first mobile device based on an end user's preferences. The first mobile device can be operably coupled to a network. The method can further include the steps of transmitting an audio signal from an advertising transmitter, storing advertising-based content on a first server, storing test market data on a second server, and receiving advertising-based content from the first server over the network.

The method can further include the step of receiving advertising-based content from the first server over the network. The audio signal can be further converted to a digital signal by the first mobile device and transmitted to the network. The method can include the step of comparing the digital signal with advertising data stored on the first database. The method can also include the step of receiving advertising-based content attributed with the digital signal after the first server successfully compares the digital signal with the advertising data stored on the first database. The method can further include the step of transmitting the test market data to the first server to be later stored as advertising-based content. Further, the method can include the step of receiving test market data from an advertising entity, wherein the test market data can be adapted to be used during a test market campaign.

In another embodiment, the computer readable storage medium can store a program that is adapted to execute a series of instructions. The instructions can be adapted to receive an input from an end user, and the instructions can be further adapted to receive an audio signal from an advertising transmitter. The instructions can be further adapted to transmit a digital signal to a first server, receive advertising-based content from the first server, and display advertising-based content on a first mobile device. The digital signal can be based on the received audio signal.

The displayed advertising-based content can include a plurality of advertising-based content options for the end user to select from and share through at least one social media service. The displayed advertising-based content can be based on the end user's input, so as an aural-based command, a motion-based command, or a touch-based command. The end user's input can be further determined by the end user's preselected preference.

### BRIEF DESCRIPTION OF THE SEVERAL VIEWS OF THE DRAWINGS

The following Figures form part of the present specification and are included to further demonstrate certain aspects of the present invention. The invention may be better understood by reference to one or more of these Figures in combination with the detailed description of specific embodiments presented herein.

FIG. 1 illustrates a partially abstracted view of a first embodiment of a system for dynamic delivery of advertising-based content.

FIG. 2 illustrates a detailed view of the first embodiment depicted in FIG. 1.

FIG. 3 illustrates a flow diagram depicting an exemplary method of creating a profile for the program stored on a computer readable storage medium.

FIG. 4 illustrates a flow diagram depicting an exemplary method of receiving advertising-based content.

FIG. 5 illustrates a flow diagram depicting another exemplary method of receiving advertising-based content.

FIG. 6 illustrates a flow diagram depicting an exemplary method of an advertising entity verifying test market data.

FIG. 7A illustrates a front view of a first embodiment of an apparatus for dynamic delivery of advertising-based content.

FIG. 7B illustrates a rear view of the first embodiment of the apparatus depicted in FIG. 7A.

FIG. 8 illustrates another embodiment of an apparatus for dynamic delivery of advertising-based content.

While the inventions disclosed herein are susceptible to various modifications and alternative forms, only a few specific embodiments have been shown by way of example in the drawings and are described in detail below. The Figures and detailed descriptions of these specific embodiments are not intended to limit the breadth or scope of the inventive concepts or the appended claims in any manner. Rather, the Figures and detailed written descriptions are provided to illustrate the inventive concepts to a person of ordinary skill in the art and to enable such person to make and use the inventive concepts.

### DETAILED DESCRIPTION

Applicant has created a system, method, and computer readable storage medium for dynamically delivering advertising-based content. In one embodiment, the system can include a first mobile device adapted to transfer data based on an end user's preferences, an advertising transmitter adapted to transmit an audio signal, and a network. The system can further include a first server adapted to store advertising-based content, a second server adapted to store test market data sent from an advertising entity, and an end user device adapted to receive advertising-based content. The first server can further comprise a first database adapted to store advertising-based content, and the second server can further adapted to store test market data. The first mobile device can be further adapted to receive the advertising-based content.

In another embodiment, the method for dynamically delivering advertising-based content can include the step of transferring data to and from a first mobile device based on an end user's preferences. The first mobile device can be operably coupled to a network. The method can further include the steps of transmitting an audio signal from an advertising transmitter, storing advertising-based content on a first server, storing test market data on a second server, and receiving advertising-based content from the first server over the network.

In another embodiment, the computer readable storage medium can store a program that is adapted to execute a series of instructions. The instructions can be adapted to receive an input from an end user and receive an audio signal from an advertising transmitter. The instructions can be further adapted to transmit a digital signal to a first server based on the received audio signal, receive advertising-based content from the first server, and display one or more advertising-based content options on a first mobile device, an end user device, or both. The digital signal can be based on the received audio signal.

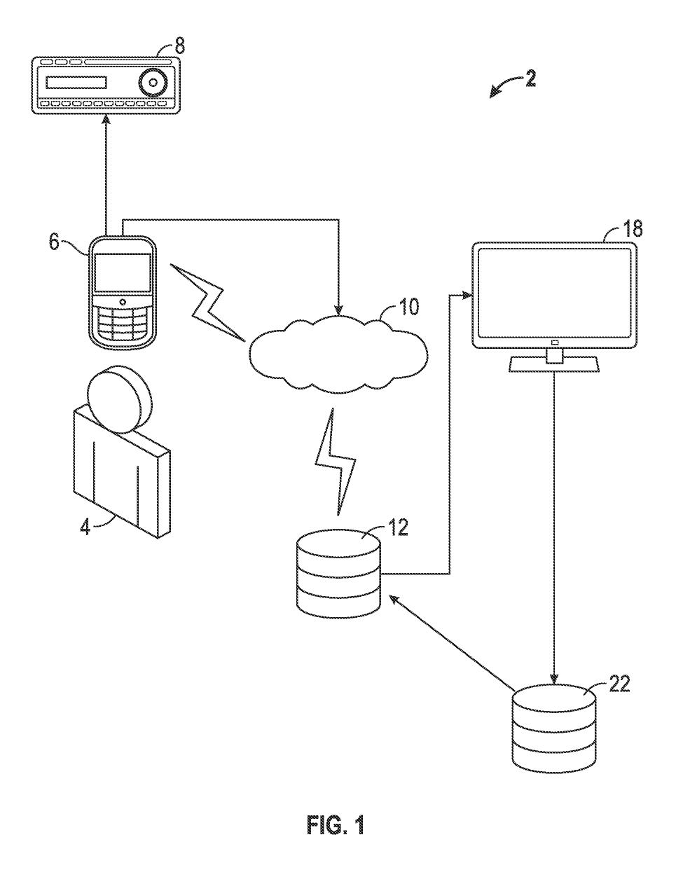

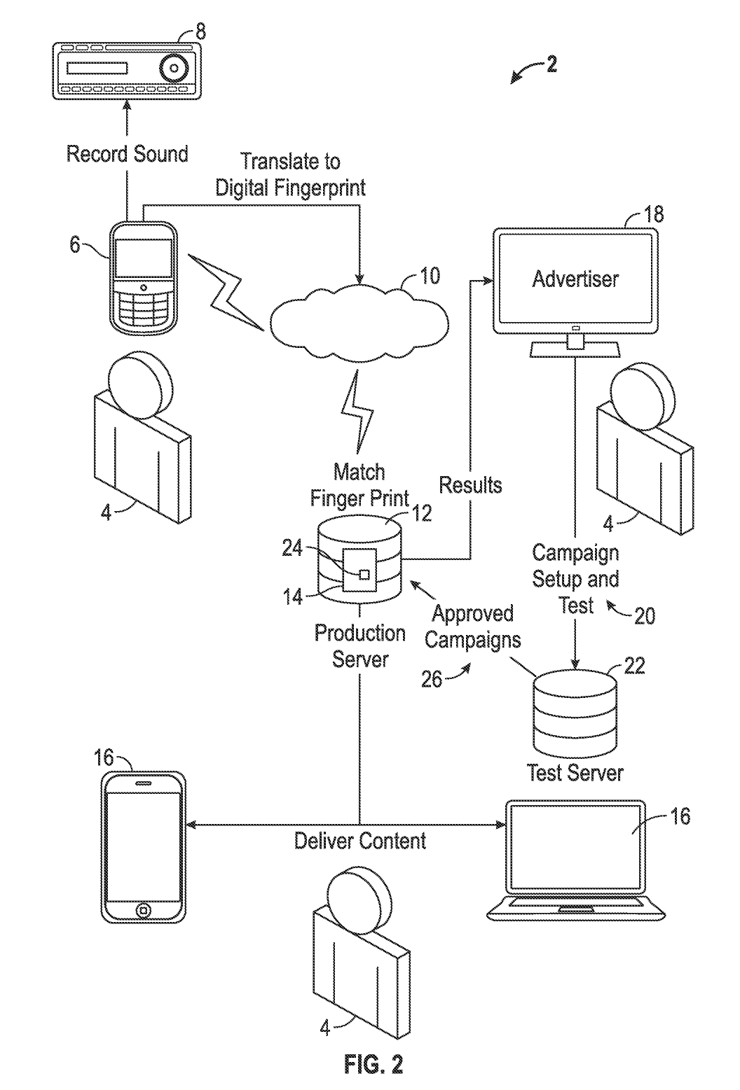

Turning now to the figures, FIG. 1 is a partially abstracted view of a first embodiment of a system for dynamic delivery of advertising-based content. FIG. 2 is a detailed view of the first embodiment depicted in FIG. 1. These figures will be described in conjunction with one another. In a first embodiment, the system 2 can include an end user 4, a first mobile device 6, an advertising transmitter 8, and a network 10. The end user 4 can include one or more human end users. Furthermore, the end user 4 can include one or more automated end users, such as an internet bot, a www robot, a web robot, web crawler, auto bots, or the like. The system 2 can further include a first server 12 which can further comprise a first database 14. The system 2 can further include an end user device 16, an advertising entity 18, and a second server 22. The first mobile device 6, the first server 12, the end user device 16, the advertising entity 18, and the second server 22 can be operably coupled to the network 10. The second server 22 can be adapted to store test market data 20, and the first server 12 can be adapted to store advertising data 24 and advertising-based content 26.

The first mobile device 6 can be any type of mobile device adapted to communicate with a network. In an exemplary and non-limiting illustrative embodiment, the first mobile device 6 can be a handheld cellular phone, such as an APPLE® iPhone®. The first mobile device 6 can further include any cellular phone, such as a BlackBerry® device, or any other portable device such as a PDA, a tablet (for example, an APPLE® iPad or iMac®), mp3 player, or electronic reader. Furthermore, the first mobile device 6 can be a computer, such as a laptop, netbook, or notebook device. The first mobile device 6 can include one or more devices adapted to communicate with the network 10. Furthermore, the first mobile device 6 can include any device capable of being mobile.

The first mobile device 6 can be adapted to receive an audio signal transmitted from the advertising transmitter 8. For example, the advertising transmitter 8 can include a radio capable of receiving AM, FM, or XM radio signals, or any other electrical, magnetic, or electromagnetic waves or signals. The advertising transmitter 8 can be portable, such as a radio unit coupled to a stereo system of a vehicle. Likewise, the advertising transmitter 8 can be incorporated into any audio system capable of producing sound waves. The sound waves can include sound waves at frequency ranges above, below, or within the normally accepted ranges of human hearing. Additionally, the advertising transmitter 8 can be coupled to any other device. For example, the advertising transmitter 8 can be coupled to the first mobile device 6. Furthermore, the advertising transmitter 8 and the first mobile device 6 can be embodied as a single device (such as a cellular phone).

The first mobile device 6 can be further adapted to transfer data based on the end user's 4 preferences. These data can be transmitted over the network 10 to the first server 12. The network 10 can include one or more networks. One or more elements disclosed in FIG. 1 and FIG. 2 can communicate with the network 10 over “hard-wired” media such as cables, optical fibers, or the like. Furthermore, the network 10 can be adapted to facilitate the transfer of data, information, or sound through wireless, infrared, radio frequencies, or the like.

The first mobile device 6 can be adapted to receive advertising-based content 26. The first mobile device 6 can be further adapted to convert an audio signal to a digital signal. Alternatively, the first server 12 can be adapted to convert the audio signal to a digital signal (e.g., a signal comprising machine-readable binary 1s and 0s). The first mobile device 6 can be further adapted to transmit the digital signal to the network 10. In an exemplary and non-limiting illustrative embodiment, the audio signal can include an audible advertisement, such as a radio advertisement. The audio signal can further include both audible and visible content or information. The digital signal can include a digital fingerprint that can be tagged with a unique number or set of numbers to identify the signal. This tagging can include tagging, mapping, keying, hashing (such as with the aid of a hash map, hash table, or the like), or any other means of associating the digital fingerprint with an audio signal. For example, the digital signal can include encoded information to uniquely identify the audio signal. Likewise, the digital signal can include any other content-specific information or data. Furthermore, the first mobile device 6 can be adapted to transmit a signal comprising an analog signal, a digital signal, or both, so that the transmitted signal can be converted to a digital signal on the first server 12.

The first server 12 can include any server adapted to store data. The first server 12 can further include a first database 14 adapted to store data. These data can include test market data 20, advertising data 24, advertising-based content 26, or any other data capable of being stored on a server. The first server 12 can include one or more servers, each including one or more databases. In an exemplary and non-limiting illustrative embodiment, the first database 14 is divided among two or more servers and adapted to store test market data 20, advertising data 24, advertising-based content 26, or any other data capable of being stored on a server. The first database 14 can include any set of data or single datum in either a structured or unstructured form.

The first server 12 can be adapted to compare the digital signal with the advertising data 24. The advertising data 24 can be further adapted to be stored on the first database 14. During the comparison, the first server 12 is adapted to compare the digital signal with the advertising data 24 to determine if there is a match. If a match occurs, the first server 12 is adapted to transmit advertising-based content 26 matched to, or attributed with, the digital signal to the first mobile device 6, the end user device 16, or both. If a match does not occur, the first server 12 is adapted to transmit a signal to the first mobile device 6, the end user device 16, or both. This signal can indicate that the digital signal and the advertising data 24 failed to produce a match.

The first server 12 can further include a conversion program (implemented in software, firmware, hardware, or the like) stored on, or executed within, the first server 12 that can execute the converting and tagging discussed above. For example, in an exemplary and non-limiting illustrative embodiment, the first mobile device 6 can transmit the audio signal to the first server 12. The first server 12 can store the audio signal in the first database 14. The first server 12 can execute the conversion program which can convert the audio signal to a digital signal including a digital fingerprint. Once converted, the digital signal and the digital fingerprint can be stored on the first server 12.

The conversion program can further compare the tag information of the digital fingerprint to the advertising data 24 to determine if there is a match. For this comparison, the advertising data 24 can be stored on the first server 24 in the first database 14. Alternatively, the advertising data 24 can be stored on a second server 22. If a match occurs, the associated advertising-based content 26 can be transmitted to the first server 12, the first mobile device 6, to the first end user device 16, or to any combination therein. Furthermore, the associated advertising-based content 26 can be transmitted to a third server (not shown). The third server can be used by the advertising entity 18 to test whether the advertising-based content 26 associated with the particular audio signal and digital signal is correct. The advertising entity 18 can access the advertising-based content 26 through any means of secured data access (such as a secured access point through a network).

In an exemplary and non-limiting illustrative embodiment, the first server 12, the second server 22, and the third server (not shown) can be combined into a single server. The single server further can include one or more databases. In other embodiments, any variation of the first, second, and third servers can be combined into one or more servers. The one or more servers can include one or more databases that can be either unique to, or shared by, each of the servers.

The end user device 16 can be adapted to receive advertising-based content 26 from the first server 12 over the network 10. The end user device 16 can include any device adapted to be coupled to the network 10. For example, the end user device 16 can include any device previously described as a possible embodiment of the first mobile device 6. Furthermore, the end user device can include one or more devices. In an exemplary and non-limiting illustrative embodiment, the end user device 16 is omitted from the system 2 and replaced by the first mobile device 6. Furthermore, the end user device 16 and the first mobile device 6 can be adapted to both receive the advertising-based content 26.

The second server 22 can include any server adapted to store data. For example, the second server 22 can include any server previously described as a possible embodiment of the first server 12. In an exemplary and non-limiting illustrative embodiment, the first server 12 and the second sever 22 can be combined as a single server. The second server 22 can be adapted to include a second database (not shown). The second server 22 can be adapted to transmit the test market data 20 to the first server 12. The test market data 20 can be stored as the advertising-based content 26 on the first server 12. The test market data 20 can further include advertising data 24.

The advertising entity 18 can include one or more human or non-human entities (such as a business organization) capable of developing, designing, modifying, or producing advertisements, test market data 20, advertising data 24, or advertising-based content 26. In an exemplary and non-limiting illustrative embodiment, the advertising entity 18 can include an entity, such as a corporation, that produces advertising-based content 26. Further, the advertising entity 18 can develop, design, or modify test market data 20 to be used in a test market campaign. During a test market campaign, the advertising entity 18 can store the test market data 20 on the second server 22 in order to confirm that the correct advertising-based content 26 is properly returned.

The test market data 20 can be employed to test whether the proper content will be returned to an end user 4. In an exemplary and non-limiting illustrative embodiment, the advertising entity 18 can store the test market data 20 on the second server 22. The advertising entity 18 can then test the system 2 by transmitting a digital signal corresponding with particular advertising-based content 26. If the second server 22 returns the matching test market data 20, the advertising entity 18 can confirm that the system is functioning properly. If anything other than the correct test market data 20 is returned (e.g., incorrect data or no data), the advertising entity 18 can further modify the system 2 (e.g., modify the test market data, the audio signal, the digital signal, its digital signature, its associated tags, the advertising data 24, the program for converting, tagging, and matching the signal to advertising-based content, etc.) to correct the mismatch. Once the advertising entity 18 is satisfied with the results of the test market campaign, the test market data 20 can be transmitted to the first server 12 to be stored as advertising-based content 26. Furthermore, the first server 12 can transmit results directly to the advertising entity 18 through the network 10. The second server 22 can further store and transmit the advertising data 24 as part of, or separate from, the advertising-based content 26.

The advertising data 24 can comprise data used to compare with the digital signal. The advertising-based content 26 can include one or more unique advertisements (not shown) or advertising-based content options. In an exemplary and non-limiting illustrative embodiment, the advertising data 24 can include metadata, such as a tag, associated with the advertising-based content 26. In this embodiment, the digital signal can be compared with the advertising data 24 to determine which of the one or more unique advertisements included in the advertising-based content 26, if any, matches the digital signal. In this example, the advertising data 24 acts as a series of one or more unique tags to be matched with advertising-based content 26. Furthermore, the advertising data 24 and the advertising-based content 26 can be combined into one set of data to be compared to the digital signal.

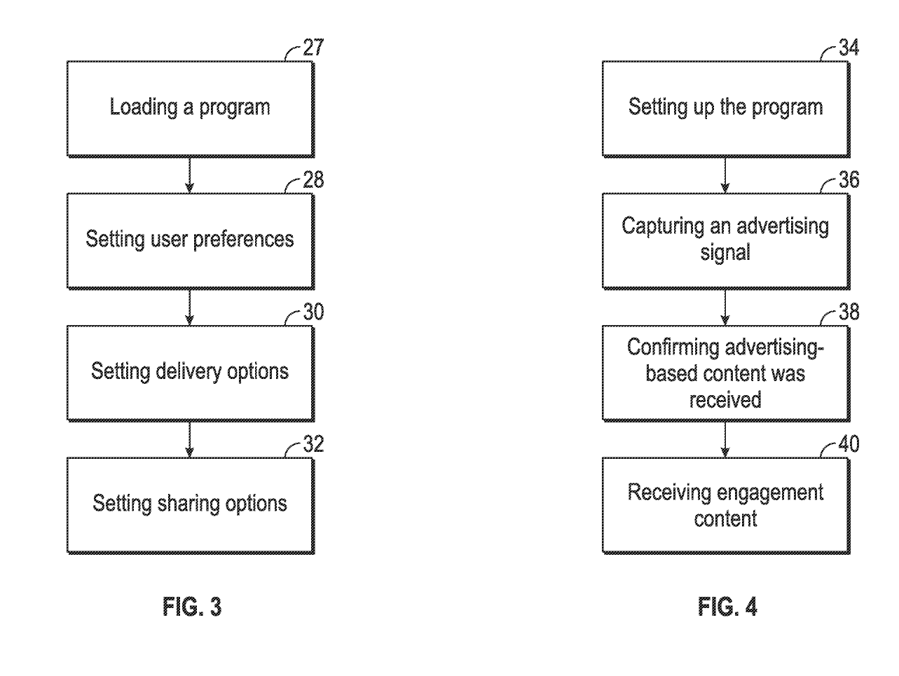

FIG. 3 is a flow diagram depicting an exemplary method of creating a profile for a program stored on a computer-readable storage medium. The program stored on the computer-readable storage medium can comprise any set of computer code (e.g., executable, non-executable, assembly, machine, compiled, or uncompiled), or instructions implemented in software, hardware, firmware, or any combination thereof. In an exemplary and non-limiting illustrative embodiment, the program can comprise a software application for a mobile device, such as an “app” for an APPLE® iPhone®. The method can include the step 27 of loading the program on a first mobile device. The method can further include the step 28 of setting one or more end user preferences for determining how an end user can configure the first mobile device to receive an input. The method can include the step 30 of setting delivery options to configure how an end user can receive advertising-based content. Furthermore, the method can include the step 32 of setting an end user's sharing options for sharing advertising content with others.

The step 27 of loading the program on a first mobile device can include an end user downloading the program through the Internet, internet, intranet, server, or through any other means that is able to transmit or transfer data or information. For example, in an exemplary and non-limiting illustrative embodiment, the end user can load the program by downloading the program from a service such as APPLE® iTunes, or the APPLE® App Store. Furthermore, the step 27 of loading the program can include an end user installing software already stored on a first mobile device. Additionally, the step 27 of loading the program can include initiating a program already stored on the first mobile device.

The step 28 of setting end user preferences can include setting preferences as to how the end user can configure the first mobile device to receive an input. For example, the step 28 can include an end user setting a preference so that the first mobile device can receive an input based on an aural-based command. In this example, the program can be configured to be voice activated. This is beneficial because it permits an end user to activate the program safely during vehicle operation. Furthermore, the step 28 can include an end user setting a preference so that the first mobile device will receive a motion-based command. In this example, the program can be configured to be activated by an end user by shaking the first mobile device. Additionally, the step 28 can include an end user setting a preference so that the first mobile device can receive a touch-based command. In this example, the program can be configured to be activated by an end user by manually touching the display of a first mobile device.

Furthermore, the step 28 can include an end user setting a preference so that the first mobile device can receive an input through any other means of providing an input to a first mobile device (for example, when an end user presses any one or more buttons or switches on a first mobile device). The step 28 of setting preferences can also include setting other preferences, such as which type of advertising-based content an end user wishes to automatically receive.

The step 30 of setting delivery options to configure how to receive advertising-based content can include setting delivery options so that the advertising-based content can be delivered via email, a browser, text message, SMS message, instant message, or any other means of communication through the Internet, internet, intranet, or any other configuration of interconnected devices. The delivery options can include delivering advertising-based content through one or more of these means of communication.

The step 32 of setting sharing options can include setting options to share the advertising-based content through email, mobile browser, text message, SMS message, instant message, or any other means of communication through the Internet, internet, intranet, or any other configuration of interconnected devices. Furthermore, the step 32 of setting sharing options can include setting options to share advertising-based content through social media. For example, the advertising-based content can be shared through services such as FACEBOOK®, TWITTER®, or LINKEDIN®. The advertising-based content can be shared with any social media site adapted to allow two or more end users to interact with one another.

FIG. 4 is a flow diagram depicting an exemplary method of receiving advertising-based content. The method of receiving advertising-based content can include step 34 of setting up the program. The method can further include the step 36 of capturing an advertising signal. Further, the method can include the step 38 of confirming the advertising-based content was received. Additionally, the method can include the step 40 of receiving engagement content.

The step 34 of setting up the program can include the step 28 (as shown in FIG. 3) of setting an end user preference for determining how an end user can configure the first mobile device to receive an input, the step 30 (as shown in FIG. 3) of setting delivery options to configure how to receive advertising-based content, and the step 32 (as shown in FIG. 3) of setting an end user's sharing options for sharing advertising content with others. The step 34 of setting up the program can further include any means of configuring a program for use by an end user.

The step 36 of capturing an advertising signal can include an end user receiving an advertising signal transmitted from the advertising transmitter. The advertising signal can be transmitted along with the audio signal transmitted by the advertising transmitter. The signal can include a distinct tone, sound, or other audio or visual cue for the end user to recognize that advertising-based content may be associated with the advertisement transmitted from the advertising transmitter. For example, the audio signal can indicate to the user that content or other information is embedded in the audio signal that can be captured with the program. Once the end user recognizes the advertising signal, the end user can initiate the program. Alternatively, the program can be initiated prior to the end user receiving the advertising signal. The step 36 of capturing an advertising signal can further include capturing the audio signal and the advertising signal in accordance to the preference set by the user in step 28 (as shown in FIG. 3). For example, the end user can capture the audio signal and the advertising signal by shaking the first mobile device.

Once captured, the step 38 of confirming the advertising-based content was received can include the end user receiving a confirmation indicator indicating that advertising-based content was received. The confirmation indicator can include a vibration, an aural tone, or any other audio, visual, or mechanical cue to indicate that advertising-based content is available to the end user. The step 38 of confirming the advertising-based content was received can also include a confirmation indicating that advertising-based content was not received, or that there is no advertising-based content available. This confirmation can include a vibration, aural tone, or any other audio, mechanical, or visual cue (such as a message) that is different than the confirmation indicator indicating that advertising-based content was received.

The step 38 of confirming the advertising-based content was received can include the end user receiving a confirmation indicator irrespective of whether the advertising-based content was received or not. In this example, the step 38 of confirming the advertising-based content was received can include a vibration, an aural tone, or any other audio, visual, or mechanical cue to indicate that an attempt to match the digital signal with advertising data is complete.

If the advertising-based content includes more than one unique advertisement, the step 38 of confirming if the advertising-based content was received can include an end user selecting what advertising-based content she wishes to receive. For example, the end user can receive advertising-based content that is based on a web page, or the end user can receive advertising-based content that is in the form of an online video, such as a YOUTUBE® video. The end user can make this selection manually, or the selection can be predetermined during the step 28 (as shown in FIG. 3) during the step of setting preferences.

The step 40 of receiving engagement content can include receiving engagement content through a visual interface. The engagement content can include content that allows the end user to select the advertising-based content as one or more unique advertisements. For example, the engagement content can include a video, a coupon, or a link to the advertising entity's website or webpage. The end user can make a selection from the available engagement content options. If the content is a website URL, a video, one of the standard templates available through the program, an email, text message, SMS message, or the like, the advertising-based content can be displayed in a contemporaneous fashion, or it can be saved for future display. Likewise, the step 40 of receiving engagement content can include notifying the end user through an audio or visual message that content is available to be viewed. In one embodiment, engagement content can include one or more unique advertisements among the advertising-based content. In another embodiment, engagement content can be limited only to advertisements among advertising-based content from which an end user may interact (e.g., a link to a webpage where an end user may further link to additional advertising-based content).

The advertising-based content can include engagement content with a number of different engagement options. The engagement options can be built through standardized features or they can be customized by advertising entities or other third parties. The engagement options can include how web-based content is delivered, the type of content including videos (from websites such as YOUTUBE®, GOOGLE® videos or the like), coupons, “buy now” URL links, donations, ticket purchases, auctions, or other e-commerce transactions. The engagement options can also provide end users with an opportunity to record and transmit feedback to advertising entities.

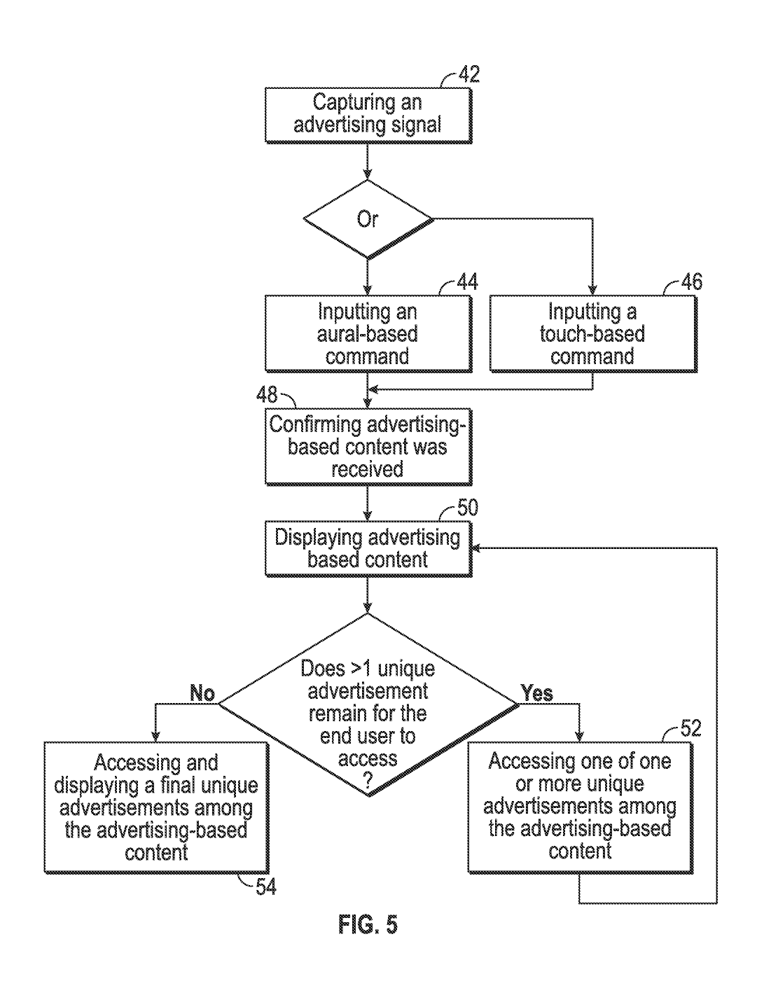

FIG. 5 is a flow diagram depicting another exemplary method of receiving advertising-based content. The method of receiving advertising-based content can include step 42 of capturing an advertising signal. The method can further include either the step 44 of inputting an aural-based command, or the step 46 of inputting a touch-based command. Though not depicted in FIG. 5, the method can include both the step 44 of inputting an aural-based command, and the step 46 of inputting a touch-based command. The method can further include the step 48 of confirming that the advertising-based content was received and the step 50 of displaying advertising-based content. Furthermore, the method can include the step 52 of accessing one of the one or more unique advertisements among the advertising-based content, and the step 54 of accessing and displaying a final unique advertisement among the advertising-based content.

The step 42 of capturing an advertising signal can include an end user receiving an advertising signal transmitted from the advertising transmitter. The advertising signal can be transmitted along with the audio signal transmitted by the advertising transmitter. The signal can include a distinct tone or other audio or visual cue for the end user to recognize that advertising-based content may be associated with the advertisement transmitted from the advertising transmitter. Once the end user recognizes the advertising signal, the end user can initiate a program. Alternatively, the program can be initiated prior to the end user receiving the advertising signal.

The step 42 of capturing can be completed by an end user performing either the step 44 of inputting an aural-based command, or the step 46 of inputting a touch-based command. An aural-based command can include any command generated at least in part by sound or sound waves. For example, the aural-based command can include voice activation. A touch-based command can include any command generated at least in part by an end user making contact with any component of the advertising-based content system. For example, a touch-based command can include an end user touching a display of a first mobile device. Alternatively, the step 42 of capturing can be completed by a motion-based command (not shown). The motion-based command can include an end user shaking a first mobile device. Furthermore, the motion-based command can include any motion that can be detected by an accelerometer coupled to a first mobile device.

Once captured, the step 48 of confirming that the advertising-based content was received can include the end user receiving a confirmation indicator indicating that advertising-based content was received. The confirmation indicator can include a vibration, an aural tone, or any other audio, visual, or mechanical cue to indicate that advertising-based content is available to the end user. The step 48 of confirming that the advertising-based content was received can also include a confirmation indicating that advertising-based content was not received, or that there is no advertising-based content available. This confirmation can include a vibration, aural tone, or any other audio, mechanical, or visual cue (such as a message) that is different than the confirmation indicator indicating that advertising-based content was received.

The step 50 of displaying advertising-based content can include any means of outputting advertising-based content to an end user. For example, the step 50 of displaying can be implemented with the aid an LCD, LED, CRT, plasma, or any other display format or configuration. The step 50 of displaying advertising-based content can include displaying advertising-based content in one or more different forms. For example, the form of the display can include one or more unique advertisements including, but not limited to, a picture, a video, a coupon, or a link to the advertising entity's website or webpage, an email, text message, SMS message, or any other electronically-based advertisement form.

An advertising entity can include more than one unique advertisements among the advertising-based content. For example, the advertising-based content can include a coupon, a URL link, and a video. In this example, the step 52 of accessing one of the one or more unique advertisements among the advertising-based content can include an end user viewing the coupon first, the video second, and the URL link third. In this example, the method can include the following steps: the step 50 of displaying advertising-based content (e.g., the coupon), the step 52 of accessing one of the one or more unique advertisement (e.g., the URL link), the step 50 of displaying advertising-based content (e.g., URL link and related content), and the step 54 of accessing and displaying a final unique advertisement (e.g., the video). This example illustrates the iterative and recursive nature of the method to permit an end user to access more than one unique advertisement from among the advertising-based content.

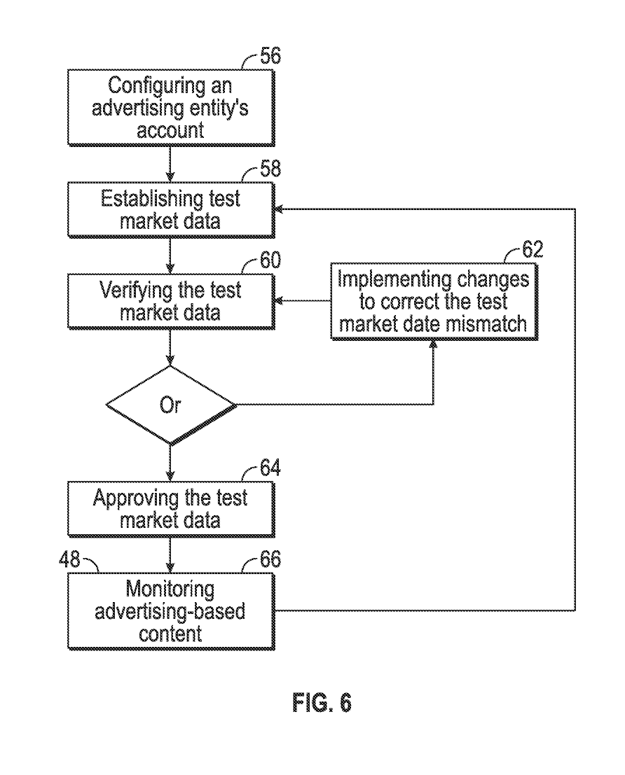

FIG. 6 illustrates a flow diagram depicting an exemplary method of an advertising entity verifying test market data. The method can include the step 56 of configuring an advertising entity's account, the step 58 of establishing test market data, and the step 60 of verifying the test market data. The method can further include the step 62 of implementing changes to correct the test market data mismatch. The decision to continue to step 64 (approving the test market data) or to step 62 (implementing changes to correct the test market data mismatch) can depend on whether or not the correct advertising-based content was returned after an advertising entity attempts to match a digital signal with the test market data. Additionally, the method can include the step 66 of approving the test market data. If changes to an advertising campaign are subsequently required, the method can include returning to the step 58 of establishing test market data and continuing through the same process as described above.

The step 56 of configuring an advertising entity account can include an advertising entity establishing a profile comprising profile information, reporting preferences, user and roles, and billing methods. The profile information can include names, companies, addresses, phone numbers, email address, company types (e.g., radio station, radio network, advertiser, media buyer, agency, other), and product categories (e.g., beverage, QSR, automotive, clothing, etc.). The users and roles section can include administrative rights, results of previous and current campaigns, upload locations, report information (including received reports and “blind” results for stations or networks). The reporting preferences can include the type of report, frequency of the reports, and recipients of the reports. The billing methods can include types of billing methods such as credit cards, invoices, or the like. The step 56 can further include establishing resources for test market campaigns.

The step 58 of establishing test market data can include setting a start date, an end date, a campaign name, an advertisement name, markets to penetrate, TRPs, length, stations to organize, trafficking numbers, brands, and spot formats. The step 58 of establishing test market data can further include creating a template for standardizing the program. For example, the template can include designating the “look and feel” of the program for an end user, or assigning URLs. The advertising entity can further approve a campaign and campaign content with the use of the template.

The step 58 of establishing test market data can also include creating a campaign manager. The campaign manager can track current and past campaigns. For example, the advertising entity can view, edit, and delete templates, view or listen to advertising spots, or view or modify other options associated with the campaign. Furthermore, the campaign manager can be used to view all elements of a previous campaign. This feature can allow an advertising entity to copy or clone previous campaigns in order to quickly and efficiently set up new campaigns. When accessing past campaigns, an advertising entity can view, edit, or otherwise modify templates, and view or listen to previous or current advertising spots.

As discussed above, the campaign manager can track current and past campaigns. By tracking these campaigns an advertising entity can measure the effectiveness of an advertisement without the use of interviews. For example, the campaign manager can be adapted to track the number of downloads, views, interactions, or other viewing habits of end users with respect to advertising entities' advertising-based content. More specifically, the campaign manager can track which product websites the end users view, how often they view the content (e.g., access a particular website), and the amount of time the end user spent viewing the content. By collecting and analyzing these data, advertising entities can quickly measure the effectiveness of their current and past advertisements. This information can be used for future campaigns to maximize an advertising entity's overall marketing strategies.

The step 58 of establishing test market data can further include creating test market data. Test market data can include one or more unique advertisements that can be later stored as advertising-based content. The test market data can be used by an advertising entity to test whether or not the digital signal associated with the test market data will properly return the test market data before the advertising-based content is launched into the system for end users to access. In an exemplary and non-limiting illustrative embodiment, the test market data is an identical version of the advertising-based data to be accessed by the end users. In this embodiment, when the advertising entity verifies the test market data, the proper advertising-based content is returned, thus reassuring the advertising entity that the system will work properly for that particular advertising-based content once it is launched into the system.

Furthermore, during a test market campaign, test market data can include several versions of different advertising-based content. For example, the test market data can include more than one unique advertisement. Each of these unique advertisements can be randomly delivered to a mobile device or an end-user device for a specified time period in order to test the effectiveness of each of the unique advertisements. For example, in an exemplary and non-limiting illustrative embodiment, five unique advertisements can be included in the test market data, advertising-based content, or both, so that each end-user will randomly receive one of these advertisements each time the end-user receives the test market data or advertising-based content. Analytical and statistical data can be recorded in order to monitor the effectiveness of each of the five unique advertisements in accordance with the step 66 of monitoring advertising-based content as described below. By doing so, the best performing unique advertisement (within the specified time period) among these five unique advertisements can be selected for broad distribution among the entire system.

The step 60 of verifying the test market data can include transmitting test market data to the second server. The test market data can be stored with or without the aid of a database on the second server. Once stored, the advertising entity can transmit a digital signal associated with the advertising-based content to the second server to confirm that the system is functioning properly. The second server can compare the digital signal (which can include a digital fingerprint) with the test market data. If the second server returns the matching test market data, the advertising entity can confirm that the system is functioning properly. In this case, the method can continue to step 64 (approving the test market data). If anything other than the correct test market data is returned (e.g., incorrect data or no data), the method can continue to step 62 (implementing changes to correct the test market data mismatch).

In an exemplary and non-limiting illustrative embodiment, the step 60 of verifying the test market data can include transmitting an audio signal to the second server. In this embodiment, the second server can convert the audio signal to a digital signal (which can include a digital fingerprint). The second server can further compare the digital signal with the test market data and the server can be adapted to compare the digital signal with test market data stored on the second server. If the second server returns the matching test market data, the advertising entity can confirm that the system is functioning properly. In this case, the method can continue to step 64 (approving the test market data). If anything other than the correct test market data is returned (e.g., incorrect data or no data), the method can continue to step 62 (implementing changes to correct the test market data mismatch).

The step 62 of implementing changes to correct the test market data mismatch can include making one or more modifications to the system (e.g., modifying the test market data, the audio signal, the digital signal, its digital signature, its associated tags, the advertising data, the program for converting, tagging, and matching the signal to advertising-based content, etc.) to correct the mismatch. The step 62 of implementing changes to correct the test market data mismatch can further include running a diagnostic test on the test market data to ascertain whether or not the mismatch occurred because of the test market data, or any other signal or component of the system. Once the problem is identified, the step 62 of implementing changes to correct the test market data mismatch can include making the necessary changes to one or more signals, data, or components before returning to the step 60 of verifying the test market data.

Once the advertising entity is satisfied with the results of the step 60 of verifying the test market data, the method can include the step 64 of approving the test market data. The step 64 of approving the test market data can include transmitting the test market data to the first server to be stored as advertising-based content. In an exemplary and non-limiting illustrative embodiment, the test market data can include advertising data. In this embodiment, the test market data and advertising data can be transmitted to the first server. In another embodiment, the test market data can be transmitted to the first server and the advertising data can remain stored on the second server. In another embodiment, the advertising data can be transmitted to the first server and the test market data can remain stored on the second server as advertising-based content. Throughout an advertising campaign, the advertising data and the advertising-based content can remain stored in each of their respective locations, or these data can be transmitted between and among other servers or databases throughout the lifecycle of an advertising campaign.

The step 66 of monitoring advertising-based content can include periodically or continuously monitoring the effectiveness of a particular advertising campaign. For example, the step 66 of monitoring advertising-based content can include reviewing end user reports. More specifically, the reports can include Real-Time Reporting. With Real-Time Reporting several engagement metrics are measured in order to determine the effectiveness of the campaign (e.g., views by content, tags, the effectiveness based on TRPs and media buy, or the like). The step 66 of monitoring advertising-based content can further include drill-down or roll up reporting. With these types of reporting techniques, the advertising entity can assess the effectiveness of the campaign by reviewing reports based on brands, mobile browser types, application-specific views, end user sharing, or the like. The step 66 of monitoring advertising-based content can further include viewing, exporting, printing, or organizing data based on listeners' and viewers' preferences. For example, the advertising entity can export a list of end users to a spreadsheet who have opted-in to certain campaigns.

In an exemplary and non-limiting illustrative embodiment, one or more advertising entities can perform the steps of FIG. 6 by accessing, creating, modifying, or manipulating the information through the use of a website or webpage. The website can include links, pages, or other content to organize the information and features available to the advertising entities before, during, and after the test market campaign. For example, the website can include links available to the general public, a home page link, a homepage support link, and other linked elements. The website can further include a user administrative panel, a link for creating a campaign, a campaign manager, reporting links, resource links, and a section dedicated to advertisement listeners, viewers, or any other combination therein. For example, the resources link can include a list of best practices, a community forum (either for general access or restricted to members only), a help page, online help, or any combination thereof, and a location for end users or advertising entities to access contact information (e.g., a “Contact Us” link). These website-based features can be embodied in alternative interfaces as well. For example, the features can be made available through any web-based, electronically-based, or computer-based interface capable of accepting inputs, and transmitting or displaying outputs.

The website can be configured so that only the home page and homepage support pages are available to the public, and the remaining pages, links, or features are only available to advertising entities that have an active account and are presently logged into the system. Alternatively, any combination of the links, pages, or features described can be either included for general access, or excluded and controlled by access through registered or authorized accounts.

The website can further include a “Dashboard” feature that can allow access to more detailed reporting information on current or past campaigns. For example, by employing the Dashboard, an advertising entity can drill into current and past campaigns and advertisements, advertising information, billing information, or the like. The Dashboard can further allow the advertising entity to administer work flow processes and create reports. When logged into the Dashboard, the advertising entity can see a visual representation of key metrics, workflow processes, and basic reporting options. The advertising entities can further use the Dashboard to set up new administrative users and otherwise assist users within web-based communities.

The Dashboard feature can include work flow processes (e.g., processing for listing all items requiring approval, providing tools for testing and validating, and simultaneously approving multiple ideas) and administrative roles (e.g., setting up users at different levels, universal rights, and customer support features). The customer support feature can allow the advertising entity to log into the website as an advertising entity and track its transactions through the website interface. The Dashboard can include a reporting section for providing immediate access to key reports and exception reports. Furthermore, the Dashboard can include key metrics represented visually with an ability to download the report, and otherwise search and sort options in order to quickly find other advertising entities, campaigns, advertising numbers, advertisements, brands, and other related details.

The website can further include a Workflow feature. The Workflow feature can include different triggering events. These triggering events can include when an advertising entity wishes to be invoiced rather changed electronically through debit-based or credit card-based payments, or when an advertising entity sets up or edits an advertisement or campaign. With either of these trigging events, both the Dashboard administrator and the website provider can receive a notification (for example, through email). If the advertising entity sets up or modifies an advertisement or campaign, Dashboard can be updated, and the website provider can test the pages and links. Furthermore, the Workflow feature can be configured so that certain advertising entities can be flagged as “special” wherein those entities can get a higher level of review, if necessary.

The website can further include an Exceptions feature. The Exceptions feature can provide more transparency into the advertising entities' data. For example, the Exceptions feature can perform a sanity check on TRPs, media buy, or other metrics that can be selected for pricing. The Exceptions feature can subsequently generate a report using empirical data from past campaigns and develop high and low ranges for engagement metrics. Furthermore, any advertisements or campaigns that fall outside acceptable ranges (e.g., high or low) can be included in a report and sent to a website provider. This information can be further sent to, or displayed through, the Dashboard feature.

The website can further include a Creation Tool feature. The Creation Tool feature can provide an advertising entity with the tools to produce its own, fully customizable, advertising-based content. For example, the Creation Tool can provide the advertising entities with a set of standard tools to quickly create advertisements in a variety of different formats (e.g., coupons, video clips, webpages, etc.). Furthermore, an advertising entity can use the Creation Tool feature to quickly modify previously created advertising-based content. Additionally, advertising entities or site administrators will be able to configure settings with the Creation Tool that sets one or more time parameters to go live (i.e., launch the campaign). With this feature, advertising entities or site administrators can develop customizable advertising-based content to be released at a time of its designation or liking.

The Creation Tool is further advantageous because it can be used to rapidly deploy modified or additional advertising-based content throughout a particular campaign. For example, if an advertising entity determines that its current advertising-based content is not tracking well, it can utilize the Creation Tool to quickly and efficiently incorporate changes to the advertising-based content that are better-suited for its target audience. By doing so, changes can be implemented immediately and rereleased to allow subsequent end users to receive the updated advertising-based content.

Furthermore, advertising entities can use the Creation Tool feature to create and test their advertising-based content through the use of preloaded templates. With these templates, the advertising entities can test the content directly through the website. The Creation Tool feature can further be configured to permit the advertising entities to deliver the advertising-based content back to a mobile device or an end-user device once the advertising-based content has been created. As an alternative to the preloaded templates, the Creation Tool can allow advertisers to create their own unique advertising-based content. This feature improves the advertising entities' freedom in developing one-of-a-kind, specifically tailored, advertising-based content.

In an exemplary and non-limiting illustrative embodiment, general access to the Creation Tool can be prohibited so that only advertising entities can access the tool through registered or authorized accounts with a secured connection. Alternatively, a modified version of the Creation Tool (Creation Tool Lite) can be included as part of the general access portion of the website. With Creation Tool Lite, an unregistered user (such as a prospective advertising entity) can access a modified version of the standard Creation Tool in order to test its features and versatility relative to their particular products and services before obtaining a registered account.

Furthermore, once an advertising entity completes a particular campaign with the tools provided by the Creation Tool feature, the campaign manager can be used to download the advertising-based content directly into a database. In an exemplary and non-limiting illustrative embodiment, the advertising-based content, once complete, can be stored in the second database. Once stored, the advertising-based content can include advertising data, one or more unique advertisements, or both. Both the advertising data and the one or more unique advertisements can be converted to a digital signal and stored on the second database. Once stored as a digital signal, the data can be compared with a digital signal transmitted by a first mobile device to determine if a match occurs. Once matched, the advertising-based content that was created by the Creation Tool and associated with that digital signal can be transmitted to an end-user device, a mobile device, or both.

The method illustrated in FIG. 6 can be employed in a cyclical fashion throughout the life of a particular advertisement campaign. For example, once the steps 56 (configuring an advertising entity's account), 58 (establishing test market data), 60 (verifying the test market data), and 64 (approving the test market data) are performed, the advertising entity can use the step 66 of monitoring advertising-based content to determine whether or not necessary or discretionary modifications to the campaign are required. If the advertising entity determines such modifications are required, the method can return to step 58 of establishing test market data (e.g., new test market data, a modified version of the original test market data, etc.). Once modified, the method can return to the step 60 of verifying the test market data before the newly modified test market data is launched throughout the system as advertising-based content. These steps can be continued in an iterative and recursive fashion so that an advertising entity can tweak the campaign to be better-suited for its target end users or consumers. Any further changes can be later inputted in accordance with the description set forth for the step 58 of establishing a test market data.

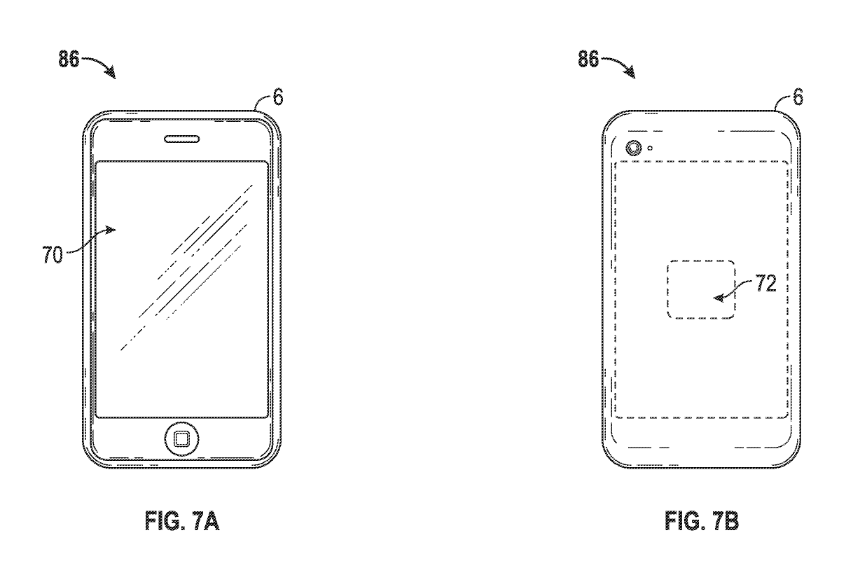

FIG. 7A illustrates a front view of an exemplary first embodiment of an apparatus for dynamic delivery of advertising-based content. FIG. 7B illustrates a rear view of the first embodiment of the apparatus depicted in FIG. 7A. These Figures will be described in conjunction with one another. The apparatus 68 can include a first mobile device 6 that can include a display unit 70. The first mobile device 6 can include a computer readable medium 72. The computer readable medium 72 can further include computer readable instructions. The computer readable instructions can refer to any instructions that can be performed by a computer or processing unit.

The display unit 70 can include an LCD, LED, CRT, plasma, or any other display format or configuration adapted to be used to display data or information on an electronic device. The computer readable instructions can include executable, non-executable, assembly, machine, compiled, or uncompiled code, or any other instructions that can be read by a computer.

The computer readable medium 72 can refer to any storage medium that may be used to in conjunction with computer readable instructions. In an exemplary and non-limiting illustrative embodiment, the computer readable medium 72 can include a computer readable storage medium. The computer readable storage medium can take many forms, including, but not limited to, non-volatile media and volatile media, floppy disks, flexible disks, hard disks, magnetic tape, other magnetic media, CD-ROMs, DVDs, or any other optical storage medium, punch cards, paper tape, or any other physical medium with patterns of holes. Computer readable storage media can further include RAM, PROM, EPROM, EEPROM, FLASH, combinations thereof (e.g., PROM EPROM), or any other memory chip or cartridge.

The computer readable medium 72 can further include computer readable transmission media. Such transmission media can include coaxial cables, copper wire and fiber optics. Transmission media may also take the form of acoustic or light waves, such as those generated during radio frequency, infrared, wireless, or other media comprising electric, magnetic, or electromagnetic waves.

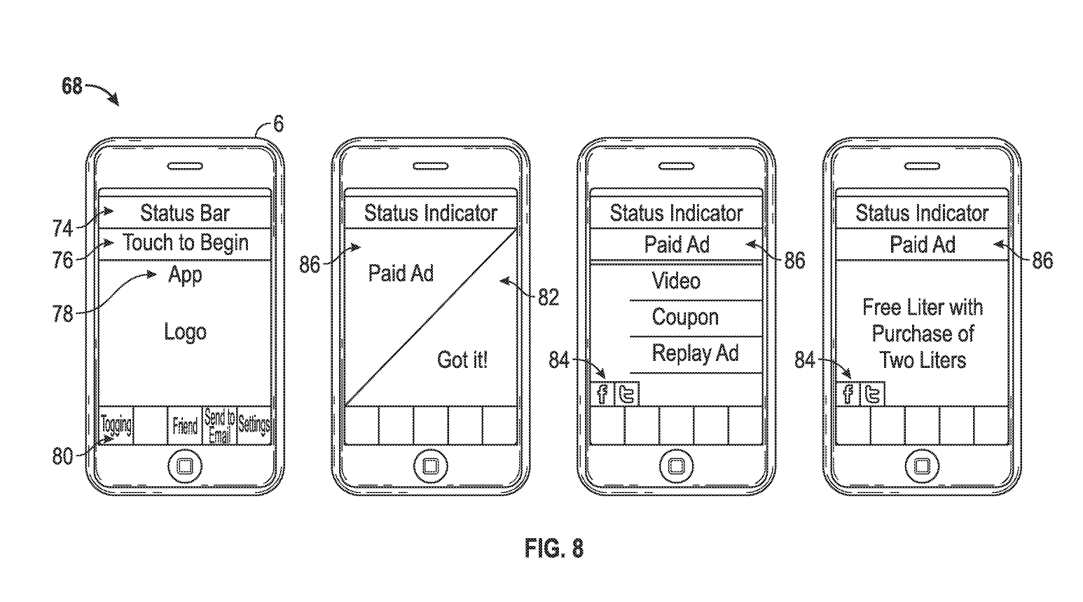

FIG. 8 is another embodiment of an apparatus for dynamic delivery of advertising-based content. The apparatus 68 can include a first mobile device 6 that can further include a display unit 70. The display unit 70 can be adapted to display a status bar 74, a touch-based start button 76, a logo 78, a menu bar 80, a confirmation area 82, a social media interface 84, and an advertisement 86.

The status bar 74 can include data, information, or messages related to the status of the program. More specifically, the status bar 74 can transmit information to an end user relating to the previous or current functions or operations carried out during the operation of the program. For example, the status bar 74 can include information that the digital signal matched the advertising data during its comparison at the first server. The touch-based start button 76 can include an area within the display unit 70 that is adapted to receive a touch-based command to begin the program. The logo 78 can include a logo, symbol, trademark, service mark, or similar mark representing the program's name. For example, in an exemplary and non-limiting illustrative embodiment, the logo 78 can be configured to display the words “AD APP,” or any other words, symbols, graphics, pictures, combinations thereof, or the like.

The menu bar 80 can include one or more subdivided areas to facilitate the program's functionality and aesthetics. The menu bar 80 can include an end user interface for tagging, establishing and monitoring profiles or settings, sending and receiving email, linking to a website or webpage, or connecting with, and sharing information among, one or more end users. The confirmation area 82 can include information, data, or messages that can be adapted to display words, symbols, graphics, or the like in order to notify an end user that the first mobile device 6 received advertising content. The social media interface 84 can include an end user interface for connecting to other social media sites, such as FACEBOOK, TWITTER, LINKEDIN, etc. for an end user to share, transmit, or distribute information related to the advertising-based content. The information can include the advertising-based content itself, an end user's commentaries, annotations, or impressions related to the advertising-based content, or a combination of two or more of these types of information. The social media interface 84 can also include an end user interface for connecting to online blogs or other media outlets that permit individual or community discussions, or any other interaction between or among two or more end users.

The menu bar 80 can further include a geo-location feature (Geo-Locate). Geo-Locate can allow an end user to employ geo-location or geo-tagging features before, during, and after receiving the advertising-based content. With Geo-Locate, the one or more unique advertisements can be custom-tailored based on an end user's location, regionally, or otherwise. In an exemplary and non-limiting illustrative embodiment, with the Geo-Locate feature activated, the advertising-based content can further include maps or other instructions for purchasing the products or services advertised in the advertising-based content based on a particular location. For example, if the advertising-based content includes a coupon for an end user's favorite restaurant, the end user can configure the Geo-Locate feature to further include a map from the end user's current location to the restaurant offering the coupon.

The end user can further modify the Geo-Locate settings so that the advertising-based content includes information relevant to a particular location, such as the end user's home, or place of employment irrespective of the end user's current location. An end user can use Geo-Locate feature for future locations as well. For example, if an end user plans to travel to a remote destination in the near future, she can enter that particular location into the apparatus in order to receive advertising-based content specifically tailored to this future destination. The location can be determined by address, intersection, municipality, city, state, or other region, landmark, point of interest, or the like. Alternatively, the location can be determined by geographical coordinates.

Other physical placements or arrangements have been contemplated for elements described in FIG. 8. For example, in one embodiment, the status bar 74 can be located at the bottom of the display unit 70 and the menu bar 80 can be located at the top of the display unit 70. Other combinations and arrangements for each of these elements, though not explicitly disclosed herein, have been contemplated as well.

The term “coupled,” “coupling,” “coupler,” and like terms are used broadly herein and can include any method or device for securing, binding, bonding, fastening, attaching, joining, inserting therein, forming thereon or therein, or otherwise associating, for example, mechanically, magnetically, electrically, chemically, operably, directly or indirectly with intermediate elements, one or more pieces of members together and can further include without limitation integrally forming one functional member with another in a unitary fashion. The coupling can occur in any direction, including rotationally.

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

Particular embodiments of the invention may be described below with reference to block diagrams and/or operational illustrations of methods. It will be understood that each block of the block diagrams and/or operational illustrations, and combinations of blocks in the block diagrams and/or operational illustrations, can be implemented by analog and/or digital hardware, and/or computer program instructions. Such computer program instructions may be provided to a processor of a general-purpose computer, special purpose computer, ASIC, and/or other programmable data processing system. The executed instructions may create structures and functions for implementing the actions specified in the block diagrams and/or operational illustrations. In some alternate implementations, the functions/actions/structures noted in the Figures may occur out of the order noted in the block diagrams and/or operational illustrations. For example, two operations shown as occurring in succession, in fact, may be executed substantially concurrently or the operations may be executed in the reverse order, depending upon the functionality/acts/structure involved.

Computer programs for use with or by the embodiments disclosed herein may be written in an object oriented programming language, conventional procedural programming language, or lower-level code, such as assembly language and/or microcode. The program may be executed entirely on a single processor and/or across multiple processors, as a stand-alone software package or as part of another software package.

Other and further embodiments utilizing one or more aspects of the inventions described above can be devised without departing from the spirit of Applicant's invention. It should be appreciated by those of skill in the art that the techniques disclosed in the disclosed embodiments represent techniques discovered by the inventor(s) to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention. For example, in one embodiment, the audio signal transmitted by the advertising transmitter can initiate the method as set forth in FIG. 5. In another embodiment, an aural-based command (such as a voice-command) can initiate the method as set forth in FIG. 5. Further, the system of FIG. 2 can omit the first server 12 entirely so that the advertising entity 18 can transmit advertising-based content 26 directly to the end user 4 over the network 10. Other variations of the systems, apparatuses, and methods can be included in combination with each other to produce variations of the disclosed embodiments. Discussion of singular elements can include plural elements and vice-versa.

In some alternate implementations, the functions/actions/structures noted in the Figures can occur out of the order noted in the block diagrams and/or operational illustrations. For example, two operations shown as occurring in succession, in fact, can be executed substantially concurrently or the operations can be executed in the reverse order, depending upon the functionality/acts/structure involved. For example, FIG. 3 illustrates one possible embodiment of a method for delivering advertising-based content. More specifically, FIG. 3 recites the step 28 of setting user preferences before the step 30 setting delivery options. Other embodiments can include performing step 30 before step 28. In some embodiments, some steps can be omitted altogether. Therefore, though not explicitly illustrated in the Figures, any and all combinations or sub-combinations of the steps illustrated in FIG. 3, or additional steps described in the Figures or the detailed description provided herein, can be performed in any order, with or without regard for performing the other recited steps.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicant intends to fully protect all such modifications and improvements that come within the scope or range of equivalent of the following claims.

What is claimed is:

1. A system for dynamically delivering advertising-based content, the system comprising:
a first mobile device adapted to transfer data based on an end user's preferences;
an advertising transmitter adapted to transmit an audio signal;
a network, wherein the first mobile device is adapted to be operably coupled to the network;
a first server, wherein the first server is adapted to store the advertising-based content; and
a second server, wherein the second server is adapted to store test market data;
wherein the first mobile device is adapted to receive the advertising-based content.

2. The system for dynamically delivering advertising-based content according to claim 1 further comprising:
an end user device, wherein the end user device is adapted to receive the advertising-based content from the first server over the network.

3. The system for dynamically delivering advertising-based content according to claim 1, wherein the first mobile device is adapted to convert the audio signal to a digital signal.

4. The system for dynamically delivering advertising-based content according to claim 3, wherein the first mobile device is adapted to transmit the digital signal to the network.

5. The system for dynamically delivering advertising-based content according to claim 3, wherein the first server is adapted to compare the digital signal with advertising data stored on a first database.

6. The system for dynamically delivering advertising-based content according to claim 5, wherein the first mobile device is adapted to receive advertising-based content attributed with the digital signal after the first server successfully compares the digital signal with the advertising data stored on the first database.

7. The system for dynamically delivering advertising-based content according to claim 1, wherein the second server is adapted to transmit the test market data to the first server to be stored on the first server as advertising-based content.

8. The system for dynamically delivering advertising-based content according to claim 1, wherein the test market data is adapted to be used during a test market campaign.

9. The system for dynamically delivering advertising-based content according to claim 1, wherein the second server is adapted to receive test market data from an advertising entity.

10. A method for dynamically delivering advertising-based content, the method comprising:
transferring data between a first mobile device and a first server based on an end user's preferences, wherein the first mobile device is operably coupled to a network;
transmitting an audio signal from an advertising transmitter;
storing the advertising-based content on the first server;
storing test market data on a second server; and
receiving the advertising-based content from the first server over the network.

11. The method for dynamically delivering advertising-based content according to claim 10, further comprising receiving the advertising-based content on an end user device.

12. The method for dynamically delivering advertising-based content according to claim 10, further comprising converting the audio signal to a digital signal.

13. The method for dynamically delivering advertising-based content according to claim 12, further comprising sending the digital signal to the network.

14. The method for dynamically delivering advertising-based content according to claim 12, further comprising comparing the digital signal with advertising data stored on a first database.

15. The method for dynamically delivering advertising-based content according to claim 14, further comprising receiving advertising-based content after the first server successfully compares the digital signal with the advertising data stored on the first database.

16. The method for dynamically delivering the advertising-based content according to claim 10, further comprising transmitting the test market data to the first server to be stored as advertising-based content.

17. The method for dynamically delivering advertising-based content according to claim 10, further comprising conducting a test market campaign with the test market data.

18. The method for dynamically delivering advertising-based content according to claim 10, further comprising receiving test market data from an advertising entity.

19. A computer readable storage medium configured to store a program for dynamically delivering advertising-based content, wherein the program is adapted to execute instructions, the storage medium comprising:
receiving an input from an end user;
receiving an audio signal from an advertising transmitter;
transmitting a digital signal to a first server, wherein the transmitted digital signal is based on the received audio signal;
receiving the advertising-based content from the first server; and
displaying the advertising-based content on a first mobile device.

20. The computer readable storage medium of claim 19, wherein the program for dynamically delivering advertising-based content is adapted to execute instructions further comprising confirming receipt of the audio signal from the advertising transmitter.

21. The computer readable storage medium of claim 19, wherein the step of displaying the advertising-based content of a first mobile device comprises displaying a plurality of advertising-based content options for the end user to select from.

22. The computer readable storage medium of claim 19, wherein the step of displaying advertising-based content is based on the end user's input.

23. The computer readable storage medium of claim 19, wherein the step of receiving an input from the end user comprises receiving at least an aural-based command, a motion-based command, or a touch-based command.

24. The computer readable storage medium of claim 19, wherein the step of receiving an input from an end user is determined by the end user's preference.

25. The computer readable storage medium of claim 19, wherein the program for dynamically delivering advertising-based content is adapted to execute instructions further comprising sharing advertising-based content data on at least one social media service.
